(19) United States
(12) Patent Application Publication
(10) Pub. No.: US 2008/0103883 A1
(43) Pub. Date: May 1, 2008

(54) Providing Feedback to an Offer for Advertising Space

(75) Inventors: Andrew Szybalski, Mountain View, CA (US); Robert Allen Ryskamp, Menlo Park, CA (US); Smita Hashim, Saratoga, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/552,796

(22) Filed: Oct. 25, 2006

(51) Int. Cl. G06Q 30/00

(52) U.S. Cl. 705/14

(57) ABSTRACT

The disclosure includes a system and method for providing feedback to an offer for advertising space. In some implementations, a method includes receiving an offer for advertising space associated with a print media. The print media is associated with a publisher. A likelihood that the offer will be accepted by the publisher is automatically determine in response to at least the request. The likelihood of acceptance is transmitted for display through a Web page.

### TECHNICAL FIELD

This invention relates to advertising

### BACKGROUND

Content delivery over the internet continues to improve every day. Computer users can receive e-mail, news, games, entertainment, music, books, and web pages—all with a simple Internet connection (and with improved quality on a broadband connection). Internet users also have access to a plethora of services such as maps, shopping links, images, blogs, local search, satellite images, group discussions, hosted content, and e-mail. While many of these services are free to users, such services are often accompanied by an advertisement that helps service providers defray the cost of providing these services. In addition, the advertisement may also add value to the user experience.

### SUMMARY

The disclosure includes a system and method for providing feedback to an offer for advertising space. In some implementations, a method includes receiving an offer for advertising space associated with content. The content is associated with a publisher. A likelihood that the offer will be accepted by the publisher is determined in response to at least the request. The likelihood of acceptance can be transmitted for display through a Web page.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 is a block diagram illustration an advertising system in accordance with some implementations of the present disclosure;

FIG. 2 is an example display illustrating a graphical user interface for submitting offers for advertising space in the advertising system of FIG. 1; and

FIGS. 3A to 3D is a flow diagram illustrating an example method for automatically evaluating offers for advertising space in the advertising system of FIG. 1.

### DETAILED DESCRIPTION

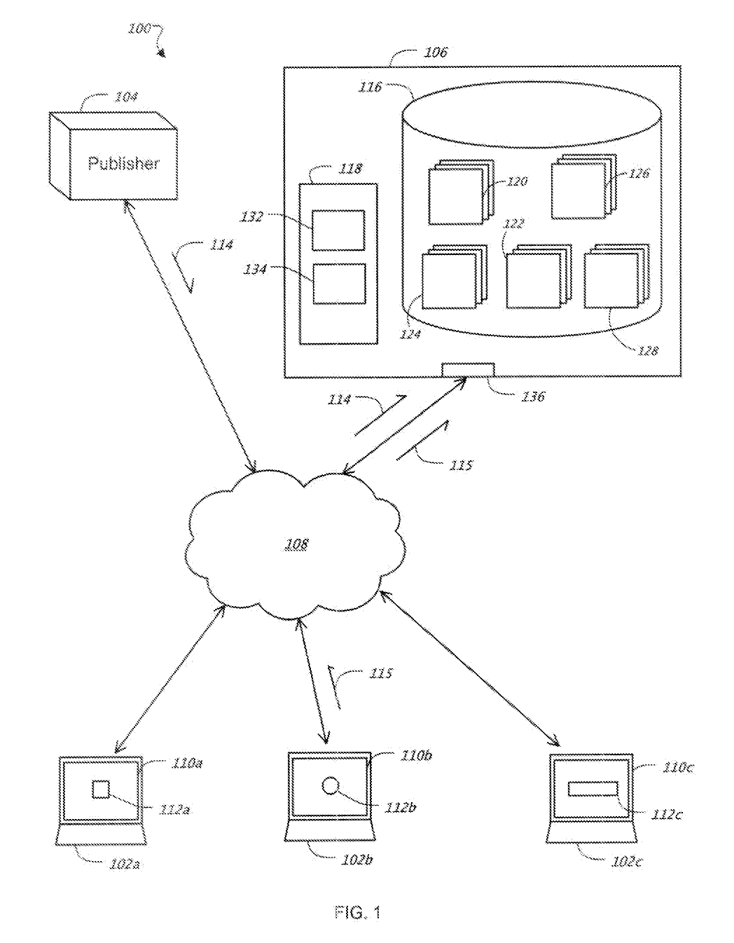

FIG. 1 illustrates an exemplary advertising system 100 for evaluating (e.g., automatically) offers to purchase advertising space. For example, system 100 may determine a likelihood that a publisher will accept an offer for advertising space. In general, advertisement (“ad”) space may include placement in print media (e.g., newspaper, magazine), a website, or any other suitable location in presented content. Typically, a publisher has a rate for an advertisement based, at least in part, on attributes of an associated ad space. Such attributes may include one or more of the following: size, amount of text, publication date, publication, section in publication (e.g., News, Sports, Home & Garden), location, type of advertisement (e.g., For-Profit, Non-Profit, Government), and/or other aspects associated with an advertisement and/or publication. In the case of print media, a publisher may specify a rate for an ad space with certain attributes, which is often referred to as a rate card. Though, a publisher may be willing to sell ad space at a price less than the rate card. To facilitate the offer and acceptance process in this case, system 100 may automatically indicate the likelihood that a specific publisher will accept an offer to purchase an ad space at less than the rate card. The likelihood of acceptance may be presented using any suitable visual and/or audio indicators such as text, color, sound, presentation of a graphic element, updating a graphical element, and/or any other suitable electronic element. In some implementations, the likelihood of acceptance includes a number to indicate whether a publisher is likely to accept an offer such as a probability or a number on a scale (e.g., 1 to 10). In some implementations, the likelihood of acceptance includes text to indicate whether a publisher is likely to accept an offer (e.g., “Longshot,” “Good chance,” “Possibly”). In addition to indicating the likelihood, system 100 may enable a user to evaluate several potential offers before the user submits an actual offer. For example, system 100 may present a graphical element for adjusting and/or receiving different potential offers and, in response to each of the potential offers, present the likelihood of acceptance for each offer. For example, system 100 may present a slider such that different offers may be evaluated by sliding the graphical element between a minimum and a maximum offer, and in response to selecting the different offers, system 100 may dynamically update the likelihood of acceptance presented to the user.

In the implementation shown, system 100 includes clients 102, a publisher 104, and an ad server 106 coupled via network 108. Clients 102a-c are any devices (e.g., computing devices) operable to connect or communicate with publisher 104, ad server 106 or network 108 using any communication link. Each client 102 includes, executes, or otherwise presents a Graphical User Interface (GUI) 110 and comprises an electronic device operable to receive, transmit, process and store any appropriate data associated with system 100. While the illustrated implementation includes clients 102a-c, system 100 may include any number of clients 102 communicably coupled to ad server 106. Further, “client 102” and “user” may be used interchangeably as appropriate without departing from the scope of this disclosure. Moreover, for ease of illustration, each client 102 is described in terms of being used by one user. But this disclosure contemplates that many users may use one device or that one user may use multiple device.

As used in this disclosure, a user of client 102 is any person, department, organization, small business, enterprise, or any other entity that may use or request others to use system 100. Client 102 is intended to encompass a personal computer, touch screen terminal, workstation, network computer, kiosk, wireless data port, smart phone, personal data assistant (PDA), one or more processors within these or other devices, or any other suitable processing or electronic device used by a user viewing content from publisher 104. For example, client 102 may be a PDA operable to wirelessly connect with an external or unsecured network. In another example, client 102 may comprise a laptop that includes an input device, such as a keypad, touch screen, mouse, or other device that can accept information, and an output device that conveys information associated with an advertisement of ad server 106, including digital data, visual information, or GUI 110. Both the input device and output device may include fixed or removable storage media such as a magnetic computer disk, CD-ROM, or other suitable media to both receive input from and provide output to users of clients 102 through the display, namely the client portion of GUI 110.

GUI 110 comprises a graphical user interface operable to allow the user of client 102 to interface with at least a portion of system 100 for any suitable purpose, such as viewing advertisements. Generally, GUI 110 provides the particular user with an efficient and user-friendly presentation of data provided by or communicated within system 100. GUI 110 may comprise a plurality of customizable frames or views having interactive fields, pull-down lists, and buttons operated by the user. For example, GUI 110 is operable to display certain network ads 118 in a user-friendly form based on the user context and the displayed data. GUI 110 may also present a plurality of portals or dashboards. GUI 110 can be configurable, supporting a combination of tables and graphs (bar, line, pie, status dials, etc.), and build real-time dashboards, where likelihood indicators 112 (as well the displayed application or transaction data) may be relocated, resized, and such. It should be understood that the term graphical user interface may be used in the singular or in the plural to describe one or more graphical user interfaces and each of the displays of a particular graphical user interface. Indeed, reference to GUI 110 may indicate a reference to the front-end or a component of evaluation engine 132, as well as the particular interface accessible via client 102, as appropriate, without departing from the scope of this disclosure. Therefore, GUI 110 contemplates any graphical user interface, such as a generic web browser or touch screen, that processes information in system 100 and efficiently presents the results to the user. Ad server 106 can accept data from client 102 via a the web browser (e.g., Microsoft Internet Explorer or Netscape Navigator) and return the appropriate HTML or XML responses to the browser using network 108, such as settings for indicators 112.

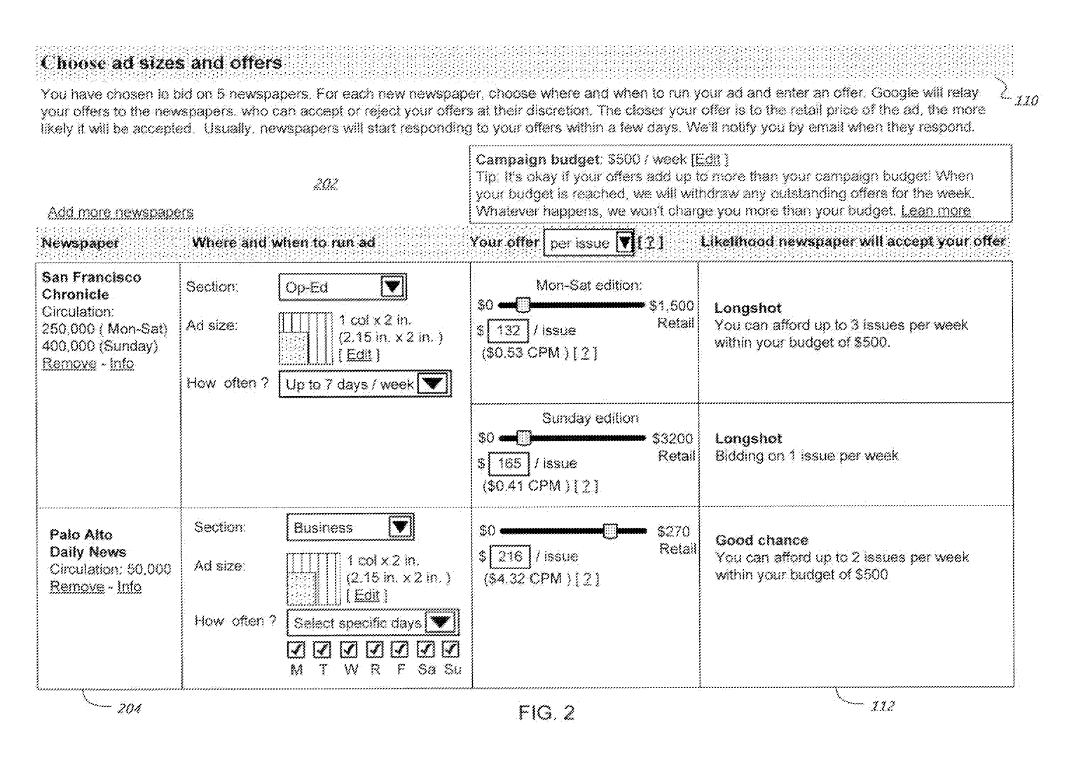

Indicator 112 may include any graphical and/or audio elements that alert, indicate, or otherwise present a likelihood that a publisher will accept an offer 115. Indicator 112 may include one or more of the following to indicate a likelihood that an offer 115 will be accepted: text, color, sound, and/or any other suitable electronic element. For example, the colors of indicator 112 may be updated in response to receiving updates to the likelihood of acceptance such that, for example, green indicates the publisher will likely accept an offer 115, yellow indicates that the publisher might accept the offer 115, and red indicates that the publisher will not likely accept the offer 115. In addition or alternatively, indicator 112 may include text indicating the likelihood of success. In short, indicator 112 may be updated and/or generated in response to a user inserting, selecting, or otherwise identifying a potential offer 115 for an ad space, as illustrated in FIG. 2.

Publisher 104 comprises an electronic device (e.g., computing device) operable to receive, transmit, process and store data associated with system 100. In the illustrated implementation, publisher 104 provides information associated with ad spaces to ad server 106. Ad-space information 114 comprises or otherwise identifies attributes of ad spaces that may be purchased from publisher 104. For example, ad-space information 114 may identify or include one or more of the following: a publisher, ad sizes, media type, different sections include in the media, publication dates, circulation numbers, a rate card, and/or any other parameters associated with an advertisement and/or media. In addition or alternatively, ad-space information 114 may include information identifying a publishers acceptance rate for certain types of offers. For example, ad-space information 114 may indicate that a publisher never accepts an offer 115 less than 50% of the rate card. In some examples, ad-space information 114 may indicate that the publisher only accepts offers that are 90% of a rate card for sports sections on Sunday. In some implementations, ad-space information 114 may merely include a history of offers, acceptances, and/or rejections and associated parameters (e.g., offer price, ad-space attributes) for various ad space.

Ad server 106 comprises an electronic computing device operable to receive, transmit, process and store data associated with system 100. System 100 can be implemented using computers other than servers, as well as a server pool. Indeed, ad server 106 may be any computer, electronic or processing device such as, for example, a blade server, general-purpose personal computer (PC), Macintosh, workstation, Unix-based computer, or any other suitable device. In other words, system 100 may include computers other than general purpose computers as well as computers without conventional operating systems. Ad server 106 may be adapted to execute any operating system including Linux, UNIX, Windows Server, or any other suitable operating system. In certain implementations, ad server 106 may also include or be communicably coupled with a web server and/or a mail server.

Ad server 106 includes memory 116 and a processor 118. Memory 116 may be a local memory and include any memory or database module and may take the form of volatile or non-volatile memory including, without limitation, magnetic media, optical media, random access memory (RAM), read-only memory (ROM), removable media, or any other suitable local or remote memory component. In the illustrated implementation, memory 116 includes ad space 118, indicator profiles 122, evaluation criteria 124, content (e.g., web pages 126) and offer files 128, but may include other information without departing from the scope of this disclosure. Here, ad space 120 refers to ad space and associated parameters for ad space in content such as newspapers, magazines, websites and other media. Local memory 116 may also include any other appropriate data such as applications or services, firewall policies, a security or access log, print or other reporting files, HTML files or templates, data classes or object interfaces, child software applications or sub-systems, and others.

Ad-space files 120 include any parameters, pointers, variables, algorithms, instructions, rules, files, links, or other data for identifying ad space that may be purchased from publisher 104 for presenting secondary content. As discussed above, ad-space files 120 may include or otherwise identify one or more of the following attributes associated with ad space: size, amount of text, publication date, publication, section in publication (e.g., News, Sports, Home & Garden), location, type of advertisement (e.g., For-Profit, Non-Profit, Government), and/or other aspects associated with an advertisement and/or publication. For example, ad-space file 120 may identify a newspaper, sections, sizes, days, rate cards, and other parameters associated with advertising in the newspaper. In some implementations, ad-space 120 identifies different rate cards for different types of ad space. For instance, ad-space file 120 may indicate that advertising in a sports section is twice as expensive as advertising in a home-and-garden section. In some implementations, ad-space file 120 may identify mathematical and/or logical expressions for determining a rate card for a certain type of ad space. For instance, ad-space file 120 may identify a value associated with each of the various attributes and the expression may determine the rate card using these values. Each ad-space file 120 may be associated with a specific publisher, a specific publication, and/or a plurality of ad-space files 120 may be associated with a single publisher or a single publication. In certain implementations, ad-space files 120 may be formatted, stored, or defined as various data structures in text files, eXtensible Markup Language (XML) documents, Virtual Storage Access Method (VSAM) files, flat files, Btrieve files, comma-separated-value (CSV) files, internal variables, or one or more libraries. For example, a particular ad-space file 120 may merely be a pointer to a third party ad space file stored remotely. In short, ad-space files 120 may comprise one table or file or a plurality of tables or files stored on one computer or across a plurality of computers in any appropriate format. Indeed, some or all of ad-space files 120 may be local or remote without departing from the scope of this disclosure and store any type of appropriate data.

Indicator profiles 122 include any parameters, variables, policies, algorithms, instructions, settings, or rules for defining settings for indicator 112. For example, indicator profile 122 may define font types, text color, background color, background texture, audio volume and/or pitch, animation colors and/or motion rate, or other settings indicator 112. Of course, the above parameters are for example purposes and may not reflect some implementations within the scope of this disclosure. Regardless of the specific settings included or defined in profile 122, such parameters may be transmitted to or activated by client 102 when client 102 receives display pages 126. Each profile 122 may be associated with a likelihood of an acceptance or multiple profiles 122 may be associated with a likelihood of acceptance. In some implementations, publishers are associated with different indicator profiles 122 such that profiles 122 may present the same likelihood of acceptance through indicator 112 differently. For example, two different profiles 122, when applied to indicator 112, may present the indicator 112 with two different colors and different text even though the instantiated indicators 112 represent the same likelihood of acceptance. Profiles 122 may be stored in one or more tables stored in a relational database described in terms of SQL statements or scripts. In other implementations, profiles 122 may be formatted, stored, or defined as various data structures in text files, HTML documents, XML documents, VSAM files, flat files, Btrieve files, CSV files, internal variables, or one or more libraries. In short, profiles 122 may comprise one table or file or a plurality of tables or files stored on one computer or across a plurality of computers in any appropriate format. Moreover, profiles 122 may be local or remote without departing from the scope of this disclosure and store any type of appropriate data.

Evaluation criteria 124 include any parameters, variables, algorithms, instructions, rules, objects or other directives for evaluating offers for ad space. For example, evaluation criteria 124 may update or otherwise identify directives for determining a likelihood that an offer 115 will be accepted by publisher 104. In some implementations, the evaluation criteria 124 identifies an expression for determining a probability that an offer 115 will be accepted by publisher 104. Alternatively or in combination, evaluation criteria 124 may identify or may be used to identify ranges of offers and likelihoods of acceptance associated each range. For example, evaluation criteria may identify three ranges and associate one or more of the following likelihoods: likely, possibly, or not likely. In some implementations, evaluation criteria 124 may be based, at least in part, on previous acceptance rates of publisher 104.

In addition to including criteria for evaluating offers, evaluation criteria 124 may include mathematical expressions for performing calculations using the offer 115, the rate card, and/or previous acceptances by publisher 104. For instance, evaluation criteria 124 may include mathematical expressions for computing probabilities of an offer 115 for ad space with specific attributes. In some embodiments, evaluation criteria 124 identify mathematical expressions for performing calculations such that the results are compared with the criteria. For example, evaluation criteria 124 may identify expressions to determine acceptance rates or other previous results associated with different attributes. Using such results, evaluation criteria 124 may define criteria such as a logical expression for evaluating a selected offer 115. For example, the criteria may include specific ranges such that each range is associated with a specific likelihood. Such ranges may be provided by publisher 104, user of ad server 106, dynamically determined by ad server 106, or any other suitable device or user associated with system 100. Evaluation criteria 124 may be based on any suitable attribute associated with an advertisement and/or publisher. For example, evaluation criteria 124 may include criteria for evaluating offers during specified holidays (e.g., Easter season, Christmas) and criteria for evaluating offers for different advertisers (e.g., non-profit, for-profit, religious, government).

In connection with evaluating offers, evaluation criteria 124 may include instructions for using indicator profiles 124 based, at least on, the likelihood of acceptance. For example, evaluation criteria 124 may indicate that specific indicator profiles 122 should be applied to indicator 112 in response to an offer 115 satisfying specific criteria. For example, in the case that an offer 115 will likely be accepted by publisher 104, evaluation criteria 124 may identify one or more indicator profiles 122 that include settings intended to convey the likelihood. In this case, indicator profile 122 may include text “Good chance” in green. In short, evaluation criteria 124 may identify criteria for evaluating selected offers and guidelines for using indicator profiles 122 based, at least in part, on the evaluation of the selected offer 115.

Web pages 126 comprise displays through which information associated with ad space can be presented to users of clients 102. In general, Web pages 126 include any machine readable and machine storable work product that may generate or be used to generate a display through GUI 110. Web pages 112 may be a file, a combination of files, one or more files with embedded links to other files, or any other suitable configuration. Web pages 126 may include text, audio, image, video, animation, and other attributes. In short, Web pages 126 comprise any source code or object code for generating a display that provides information for enabling users to submit offers for ad space in media and presents a likelihood of acceptance of the offer 115 through indicator 112. Web page 126 may be written in or based on any suitable programming language such as JavaScript.

Offer files 128 include one or more entries or data structures that identify information associated with acceptance of offers by publisher 104 in system 100. For example, offer files 128 may identify previous acceptances and rejections of offers by publisher 104. In some implementations, offer files 128 may identify acceptance and rejections associated with types of ad space by publisher 104. Offer file 128 may be associated with a single publisher 104 or multiple publishers 104 or multiple offer files 128 may be associated with a single publisher 104. In short, offer files 128 may include one or more of the following: acceptance numbers, rejection numbers, ad space attributes, publisher identifier, and/or other suitable information for evaluating potential offers.

Processor 118 executes instructions and manipulates data to perform operations of ad server 106. Although FIG. 1 illustrates a single processor 118 in server 106, multiple processors 118 may be used according to particular needs, and reference to processor 118 is meant to include multiple processors 118 where applicable. In the illustrated implementation, processor 118 executes evaluation engine 132 and criteria engine 134 at any appropriate time such as, for example, in response to a request or input from a user of server 106 or any appropriate computer system coupled with network 108. Evaluation engine 132 includes any software, hardware, and/or firmware, or combination thereof, operable to evaluate offers for ad space based on any suitable process and determine settings for indicator 112 in accordance with the evaluations. In the case of evaluating an offer 115, evaluation engine 132 may receive an offer 115 provided through GUI 110, evaluate the offer 115 using evaluation criteria 124, and determine a likelihood of acceptance by publisher 104. In some implementations, prior to evaluating offers, evaluation engine 132 may perform one or more calculations using evaluation criteria 124 and/or indicator profile 122. For example, evaluation engine 132 may identify a rate card associated with an ad space using indicator profile 122 and determine a percentage of the rate card using the offer 115. For instance, if the rate card is $100.00 and the offer 115 is $75.00, the percentage of the rate card is 75%. Regardless of calculations, evaluation engine 132 may identify criteria for evaluating the offer 115 using evaluation criteria 124. Criteria may include a number, a range, a threshold, and/or any other suitable criteria for evaluating the offer 115. Evaluating the offer 115 may include solely evaluating the value of the offer 115, evaluating results based on the offer 115, a combination of the foregoing, and/or any other suitable evaluation. In some implementations, evaluation engine 132 may compare the offer 115 and the criteria using any suitable mathematical and/or logical expression. For example, evaluation engine 132 may determine or otherwise identify ranges associated with the rate card of an ad space. For example, evaluation engine 132 may divide the range from zero to the rate card into three ranges. In this case, the three ranges may be associated with a low, medium, or high offer 115 for an ad space. In response to satisfying criteria, evaluation engine 132 may determine a likelihood that an offer 115 will be accepted by publisher 104. In the range example, evaluation engine 132 may determine a likelihood of acceptance by comparing the offer 115 to the three ranges and assign a likelihood of acceptance in accordance with the offer 115 falling within one of the ranges. In some implementations, evaluation engine 132 may determine a probability that the offer 115 will be accepted based, at least in part, on previous acceptance rates.

In connection with determining a likelihood of acceptance, evaluation engine 132 may determine settings for indicator 112 in accordance with the evaluation. In some implementations, evaluation criteria 124 includes information identifying one or more indicator profiles 122 associated with a likelihood of acceptance for an ad space in response to at least the offer 115 satisfying criteria. For example, in the case of a high likelihood of acceptance, evaluation engine 132 may identify green for a color setting and the text “Good chance.” In the case of a low likelihood of acceptance, evaluation engine 132 may identify a red color setting and the text “Longshot.”

Criteria engine 134 may dynamically modify criteria for determining the likelihood of acceptance. In some implementations, criteria engine 134 dynamically modifies evaluation criteria 124 based, at least in part, on offer files 128. For example, evaluation engine 132 may determine acceptance rates associated with specific ad space and, in response to an event, modify evaluation criteria 124 based, at least in part, on the acceptance rates. The event may include a period of time, a request of a user, information indicating acceptance of an offer 115 from publisher 104, and/or any other suitable event associated with ad space. In the case that the criteria include ranges, criteria engine 134 may automatically modify these ranges based, at least in part, on acceptances by publisher 104. For example, criteria engine 134 may broaden or narrow a range associated with a likelihood of acceptance.

Regardless of the particular implementation, “software,” as used herein, may include software, firmware, wired or programmed hardware, or any combination thereof as appropriate. Indeed, evaluation engine 132 and criteria engine 134 may be written or described in any appropriate computer language including C, C++, Java, J#, Visual Basic, assembler, Perl, any suitable version of 4GL, as well as others. It will be understood that while evaluation engine 132 and criteria engine 134 are illustrated in FIG. 1 as including individual modules, each of evaluation engine 132 and criteria engine 134 may include numerous other sub-modules or may instead be a single multi-tasked module that implements the various features and functionality through various objects, methods, or other processes. Further, while illustrated as internal to server 106, one or more processes associated with evaluation engine 132 and/or criteria engine 134 may be stored, referenced, or executed remotely. Moreover, evaluation engine 132 and/or criteria engine 134 may be a child or sub-module of another software module or enterprise application (not illustrated) without departing from the scope of this disclosure.

Ad server 106 may also include interface 136 for communicating with other computer systems, such as clients 102, over network 108 in a client-server or other distributed environment. In certain implementations, ad server 106 receives data from internal or external senders through interface 136 for storage in local memory 120 and/or processing by processor 125. Generally, interface 136 comprises logic encoded in software and/or hardware in a suitable combination and operable to communicate with network 108. More specifically, interface 136 may comprise software supporting one or more communications protocols associated with communications network 108 or hardware operable to communicate physical signals.

Network 108 facilitate wireless or wireline communication between server 106 and any other local or remote computer, such as clients 102. Network 108 may be all or a portion of an enterprise or secured network. While illustrated as single network, network 108 may be a continuous network logically divided into various sub-nets or virtual networks without departing from the scope of this disclosure, so long as at least portion of network 108 may facilitate communications of offers 115 and indicator profiles 122 between server 106 and at least one client 102. In some implementations, network 108 encompasses any internal or external network, networks, sub-network, or combination thereof operable to facilitate communications between various computing components in system 100. Network 108 may communicate, for example, Internet Protocol (IP) packets, Frame Relay frames, Asynchronous Transfer Mode (ATM) cells, voice, video, data, and other suitable information between network addresses. Network 108 may include one or more local area networks (LANs), radio access networks (RANs), metropolitan area networks (MANs), wide area networks (WANs), all or a portion of the global computer network known as the Internet, and/or any other communication system or systems at one or more locations.

In one aspect of operation, ad server 106 receives a request for available ad space for certain media. Based on the request, ad server 106 identifies display page 126 and one or more ad-space files 120 associated with the media. Ad server transmits display page 126 and the ad-space files 120 for presenting information associated with available ad space. Evaluation engine 132 receives a request to evaluate an offer 115 for an ad space with certain attributes. Based, at least in part, on the attributes of the specific ad space, evaluation engine 132 identifies evaluation criteria 124 for evaluating the offer 115. In the event that evaluation criteria 124 includes expressions for performing calculations, evaluation engine 132 determines the appropriate results and compares the results with the criteria. In response to the offer being associated with a likelihood of acceptance, evaluation criteria identifies one or more indicator profiles 122 for conveying the likelihood of acceptance through indicator 112. The identifies indicator profiles 122 are transmitted to client 102. In response to receiving ad-space information 114 from publisher 104, criteria engine 134 dynamically modifies evaluation criteria using the previous acceptance information.

FIG. 2 is an example web pages 126 including indicators 112 for indicating the likelihood of an acceptance. It will be understood that the illustrated page is for example purposes only. Accordingly, GUI 110 may include or present ad-space information, in any format or descriptive language and each page may present any appropriate advertisements in any layout without departing from the scope of the disclosure.

In the illustrated implementation, FIG. 2 illustrates a web page 126 for presenting information associated with one or more ad spaces. Web page 126 includes an information field 202 and an ad-space table 204. Information field 202 provides general instructions for submitting offers for various ad spaces. In the example, information field 202 indicates that you may submit offers for more than one media and for each offer 115 the user may select attributes associated with the ad space (e.g., section, size, frequency, specific media). In addition to operating information, information filed 202 may also include information for facilitating the process as well as information specific to the user. In the illustrated example, information field 202 indicates that the user is limited to an advertising budget of $500.00 per week. In connection with the limit, information field 202 also indicates a “Tip” for presenting information that may facilitate use of the GUI 110. In this case, the Tip indicates that the user's total offers may exceed the budget and system 100 will manage the purchase ad space such that the user's expenses will not exceed the budget.

Turning to the remainder of web page 126, ad-space table 204 includes a number of rows and columns whose intersection forms a cell. Each cell displays information associated with an ad space. In the illustrated implementation, ad-space table 204 includes the following columns: Newspaper, Where and when to run ad, Your offer, and Likelihood newspaper will accept your offer. In the Newspaper column, the content (e.g., print media) is identified along with circulation numbers associated with weekdays and weekends. In the Where-and-when-to-run-ad column, the user may select a section of the content to purchase ad space, the ad size, and how often to include the advertisement. As for the Your-offer column, the user may initially select how much ad space is requested such as issue, monthly, yearly, or other division. In regards to the specific offer, this column displays a slider such that the user may slide a graphic element between zero and the rate card. In doing so, the user selects an offer for the ad space with the specified attributes. In the illustrated implementation, the actual offer value is illustrated in a field adjacent the illustrated slider. Turning to the Likelihood-newspaper-will-accept-your-offer column, ad-space field 204 includes an indicator 112 associated with each offer for ad space. In this case, indicator 112 includes the likelihood of acceptance as text in a certain color. For those offers with a low likelihood of acceptance, indicator 112 presents the text “Longshot” in red. For those offers with a high likelihood of acceptance, indicator 112 presents the text “Good chance” in green. In addition to indicating the likelihood, indicator 112 may include text indicating how the offer can stay within the budget. For example, indicator 112 may indicate that the offer may only purchase ad space in three issues per week based on the budget.

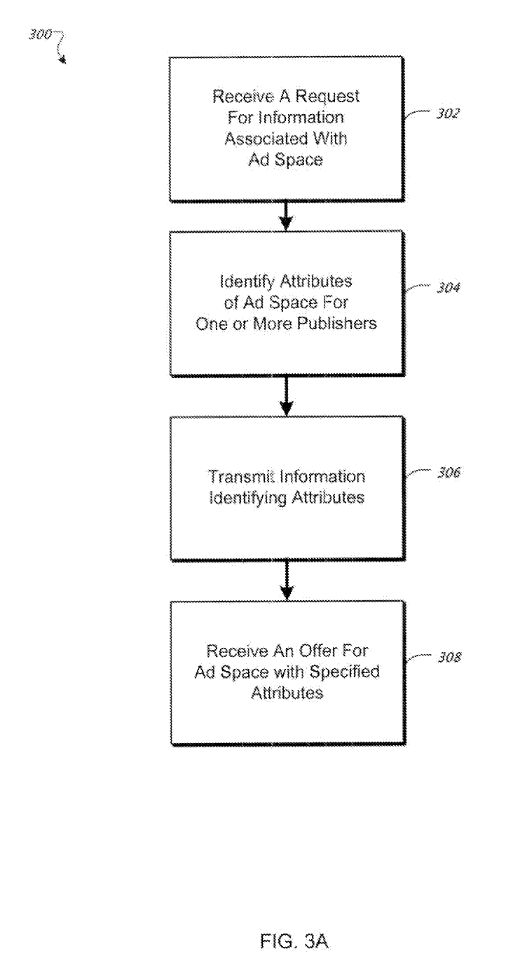

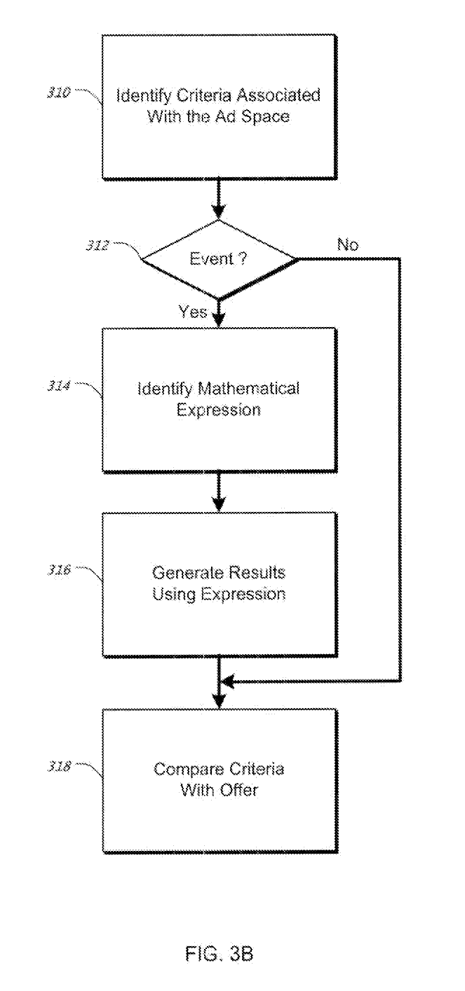

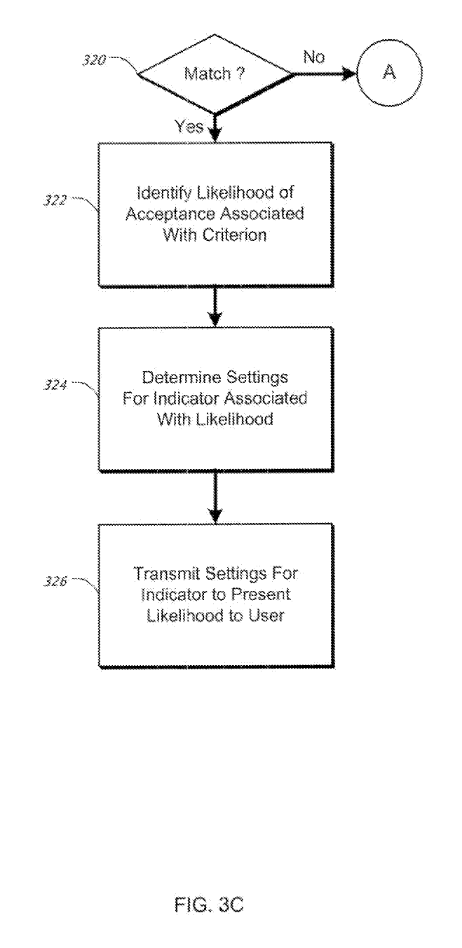

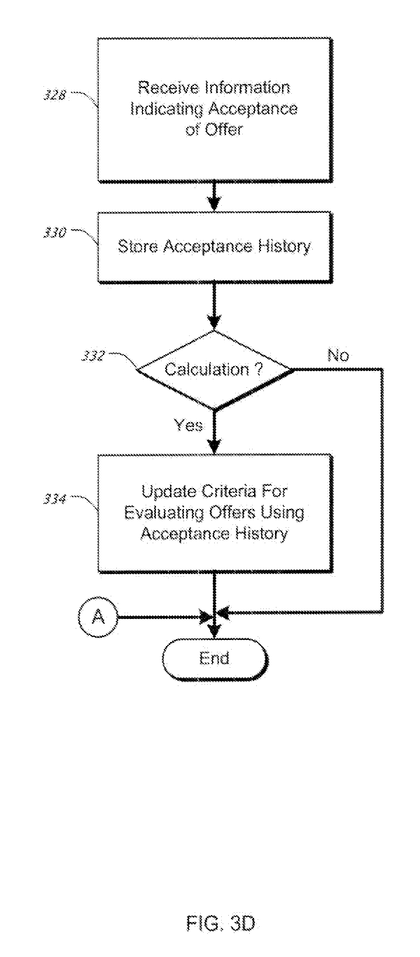

FIG. 3A to 3D is a flowchart illustrating an example method 300 for evaluating offers in accordance with some implementations of the present disclosure. Generally, method 300 describes an example technique for receiving an offer for ad space associated with content, determining a likelihood of acceptance for the offer, and transmitting information to convey the likelihood of acceptance. In addition to evaluating offers, method 300 describes dynamically modifying evaluation criteria based on previous acceptances of offers by the publisher. Method 300 contemplates using any appropriate combination and arrangement of logical elements implementing some or all of the described functionality.

Method 300 includes the following two high level processes: (1) determining a likelihood that an acceptance for ad space will be accepted in steps 302 to 326; and (2) dynamically modifying criteria for evaluating offers based on previous acceptances of the publisher in steps 326 to 334. Method 300 begins at step 302 where a request for information associated with ad space in media is requested. For example, ad server 106 may receive a request for ad space associated with, for example, a newspaper, from client 102. At step 304, attributes associated with add spaces for one or more publishers is identified. Returning to the example, ad server 106 may identify attributes such as size, dates, and sections for ad space in the newspaper in one or more indicator profiles 122. The attribute information is transmitted at step 306. In the newspaper example, the size, date, and section information is transmitted to client 102 for display through GUI 110. At step 308, an offer for ad space with specified attributes is received. Again returning to the example, ad server 106 may receive an offer that includes the following attributes: a 1 column by 2 inch size, the Business Section, seven consecutive days, rate card, and Palo Alto Daily Publisher. In response to at least the offer, criteria associated with the ad space is identified at step 310. For example, evaluation engine 132 may identify evaluation criteria 124 associated with the publisher 104 and identify criteria for evaluating the offer for the ad space with specific attributes. If a calculation is not performed in evaluation of the offer at decisional step 312, the method proceeds to step 318. If a calculation is performed in evaluation of the offer at decisional step 312, then a mathematical expression for performing the calculation is identified at step 314. In the newspaper example, evaluation engine 132 may identify an expression for determining what percentage the offer is of the associated rate card in evaluation criteria 124. At step 316, results are generated using the expression and the offer. As for the example, evaluation engine 132 may determine that the offer is 75% of the rate card. The offer is compared to the identified criteria at step 318. As discussed above, in referring to evaluating the offer, such statements may refer to either the offer or calculations based on the offer. If the offer does not match or exceed the identified criteria at decision step 320, then the method ends. If the offer matches at least a portion of the criteria, then a likelihood of acceptance associated with the matched criteria is identified at step 322. In the newspaper example, evaluation engine 132 may determine that 75% of the rate card has a good chance of being accepted by publisher 104. In some implementations, evaluation engine 132 may determine a probability of acceptance based on previous acceptances of publisher 104. In response to at least determining a likelihood of acceptance, indicator settings associated with the likelihood are determined at step 324. Again in the example, evaluation engine 132 may determine text stating “Good Chance” and a color green for the text to indicate, through indicator 112, that the offer has a good chance of acceptance by publisher 104. At step 326, the settings for the indicator to present the likelihood to a user are transmitted. In the newspaper example, evaluation engine 132 transmits the settings to client 102 for applying to indicator 112.

Turning to the process for dynamically modifying evaluation criteria, method 300 begins at step 328 where information indicating acceptance of the offer is received. The information is stored at step 330. In the newspaper example, ad server 106 may receive information indicating that publisher 104 accepted the offer and, in response to at least the information, update offer file 128 with information indicating the acceptance, the offer value, and associated ad space attributes. If an event is not identified at decisional step 332, the method ends. If an event is identified at decisional step 332, then criteria for evaluating offers is updated using the acceptance history. Returning to the example, criteria engine 134 may retrieve acceptance history from offer files 128 and dynamically modify evaluation criteria 124 in accordance with the history.

Although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A method, comprising:
receiving an offer for advertising space associated with content, the content associated with a publisher;
automatically determining a likelihood that the offer will be accepted by the publisher in response to at least the request; and
transmitting the likelihood of acceptance for display.

2. The method of claim 1, further comprising:
receiving a request for information associated with the advertising space, the advertisement including attributes; and
automatically determining the acceptance likelihood based, at least in part, on the attributes.

3. The method of claim 2, the attributes comprising at least one of a size, a publication, or dates.

4. The method of claim 1, wherein automatically determining a likelihood comprises:
identifying at least one criterion for evaluating the offer, the at least one criterion associated with a likelihood of acceptance;
determining the offer satisfies the at least one criterion; and
associating the offer with the likelihood of acceptance.

5. The method of claim 1, further comprising:
identifying settings for a graphical element associated with the likelihood of acceptance; and
transmitting the settings to a user to convey the likelihood of acceptance.

6. The method of claim 5, the settings comprising text and color.

7. The method of claim 1, the determining step based on evaluation criteria, the method further comprising:
receiving information associated with acceptance of offers by the publisher; and
dynamically modifying the evaluation criteria based, at least in part, on the acceptance information.

8. The method of claim 7, the acceptance information comprising a acceptance rates for specific advertising space.

9. The method of claim 1, the likelihood of acceptance comprising a probability that the publisher will accept the offer.

10. The method of claim 1, the likelihood comprising a first likelihood, the method further comprising:
automatically determining a second likelihood of acceptance in response to a user selecting different attributes for advertising space; and
transmitting the second likelihood of acceptance for updating the display through the Web page.

11. The method of claim 1, the likelihood of acceptance is displayed through a Web page.

12. Software for evaluating ad-space offers comprising computer readable instructions embodied on media and operable to:
receive an offer for advertising space associated with content, the content associated with a publisher;
automatically determine a likelihood that the offer will be accepted by the publisher in response to at least the request; and
transmit the likelihood of acceptance for display.

13. The software of claim 12 further operable to:
receive a request for information associated with the advertising space, the advertisement including attributes; and
automatically determine the acceptance likelihood based, at least in part, on the attributes.

14. The software of claim 13, the attributes comprising at least one of a size, a publication, or dates.

15. The software of claim 12, wherein the software operable to automatically determine a likelihood comprises software operable to:
identify at least one criterion for evaluating the offer, the at least one criterion associated with a likelihood of acceptance;
determine the offer satisfies the at least one criterion; and
associate the offer with the likelihood of acceptance.

16. The software of claim 12 further operable to:
identify settings for a graphical element associated with the likelihood of acceptance; and
transmit the settings to a user to convey the likelihood of acceptance.

17. The software of claim 16, the settings comprising text and color.

18. The software of claim 12, the determine instruction based on evaluation criteria, the software further operable to:
receive information associated with acceptance of offers by the publisher; and
dynamically modify the evaluation criteria based, at least in part, on the acceptance information.

19. The software of claim 18, the acceptance information comprising a acceptance rates for specific advertising space.

20. The software of claim 12, the likelihood of acceptance comprising a probability that the publisher will accept the offer.

21. The software of claim 12, the likelihood comprising a first likelihood, the software further operable to:
automatically determine a second likelihood of acceptance in response to a user selecting different attributes for advertising space; and
transmit the second likelihood of acceptance for updating the display through the Web page.

22. The software of claim 12, the likelihood of acceptance is displayed through a Web page.

23. A system, comprising:
a means for receiving an offer for advertising space associated with content, the content associated with a publisher;
a means for automatically determining a likelihood that the offer will be accepted by the publisher in response to at least the request; and
a means for transmitting the likelihood of acceptance for display.
